(19) United States
(12) Patent Application Publication
(10) Pub. No.: US 2004/0199787 A1
(43) Pub. Date: Oct. 7, 2004

(54) Card device resource access control

(75) Inventors: Sebastian J. Hans, Berlin (DE); Eduard K. de Jong, Bristol (NL)

Correspondence Address: David B. Ritchie, Thelen Reid & Priest, LLP, P.O. Box 640640, San Jose, CA, 95164-0640, US

(73) Assignee: Sun Microsystems, Inc., a Delaware Corporation

(21) Appl. No.: 10/805,429

(22) Filed: Mar. 19, 2004

Related U.S. Application Data
(60) Provisional application No. 60/509,047, filed on Apr. 2, 2003.

(51) Int. Cl. H04L 9/00; G06F 15/16

(52) U.S. Cl. 713/200; 709/229

(57) ABSTRACT

A card device for communication with an electronic device comprises a memory for storing a capabilities list associated with an application program. The capabilities list comprises information regarding access to one or more resources for use by the application program. The memory is also for storing the application program and a security manager. The card device comprises a processing unit for executing the application program and the security manager, for selectively granting access to the one or more resources for use by the application program based at least in part on the capabilities list.

### CROSS REFERENCE TO RELATED APPLICATIONS

This application claims the benefit of provisional patent application Serial No. 60/509,047, filed Apr. 2, 2003 in the name of Sebastian Hans and Eduard K. de Jong, entitled “Capabilities List for SmartCard Applications”, commonly assigned herewith.

The present invention relates to the field of computer science. More particularly, the present invention relates to card device resource access control.

### BACKGROUND OF THE INVENTION

Field of the Invention

Card devices such as smart cards are widely used in data transactions between users, particularly for secure data transmissions. Card devices may be used for making payments and obtaining services such as in banking applications, health care, transportation, and entertainment.

A card device can be a type of plastic card embedded with a computer chip for storing data and for data transactions between users, such as a customer and a retailer. The data stored on the card device may represent a monetary value or information or both, and can be stored in a memory and processed by a microprocessor associated with the memory. The card device forms part of a computing system comprising further computing devices for communicating with the card device and further including a reading device for reading and writing data from and to the card device to communicate the data with the further computing devices.

For example, suppose for a purchasing application a user's card device has stored therein data corresponding to a monetary value. For a purchasing transaction, the user introduces the card device into a card reader connected to a computing/accounting device of a retailer and the monetary value stored on the card device is read and reduced by the amount required for the purchase. Likewise, a value stored at the vendor's computing device may correspondingly be increased by this value, and the user can remove the card device from the reader, completing the transaction.

When storing monetary values and other sensitive or proprietary information on a card device, it is imperative that the data on the card device are secured and processed in a secure environment. Thus, means for maintaining information security are required, including appropriate encryption of data, secure data transmission techniques, and the like. Additionally, to protect the processor or memory of the smart card from manipulation, physical security of services and equipment is added. For example, the card device may be made more difficult to open without destroying the card device.

Card devices have become a very versatile tool for a growing number of applications and today are designed to host multiple different application programs for performing various services. Generally, card devices can host a complex file system that stores private data of a user, and the data is accessed and handled by multiple application programs. In order to maintain a high level of security and data confidentiality, the respective application programs on the card device should have access to only data and other resources required for the execution of the application program. Other data or resources on the card device or external thereto should not be accessible through the respective application programs. Thus, measures are required for controlling the access to data, other resources, or both, from the respective application programs.

One solution for maintaining a high level of security and data confidentiality in a computing environment including multiple applications being accessed by one or more users is to store in association with each resource information regarding the entities (i.e. users and applications) which are authorized to access the resource. For example, a data file including a text document has stored in association therewith an indication of which users, groups of users, applications, etc., may access the data file. Furthermore, the access information may also specify what kind of operation can be performed with the data file, such as read operations, write operations, or both.

Unfortunately, the above solution requires storing and maintaining on a card device in association with each resource, detailed information regarding access rights. Furthermore, to facilitate card maintenance and to improve versatility of the card devices, mechanisms to implement application programs on the card device and to remove application programs from the card device must be provided. Accordingly, each time an application program, e.g. providing a new functionality of the card device, is transferred to the card device, information regarding access rights associated with the application program also needs to be introduced. As the access rights are stored in association with resources, introducing a new application program into the card device entails modifying the access information stored in association with each resource. This process requires multiple operations to add access information regarding the new application program to each resource. In a complex environment, significant effort may be required to add an application program to a card device.

Moreover, if an application program is removed from the card device, with similar effort, the access rights of the removed application programs stored in association with the data files, other resources, or both, must be erased.

### SUMMARY OF THE INVENTION

A card device for communication with an electronic device comprises a memory for storing a capabilities list associated with an application program. The capabilities list comprises information regarding access to one or more resources for use by the application program. The memory is also for storing the application program and a security manager. The card device comprises a processing unit for executing the application program and the security manager, for selectively granting access to the one or more resources for use by the application program based at least in part on the capabilities list.

According to one aspect, when transferring an application program to a card device, a capabilities list specifying the access rights held by the application program can jointly be transferred and stored on the card device and, when executing the application program, the capabilities list can be examined to determine whether an access to a resource requested by the application program can be granted.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram that illustrates a card device in accordance with one embodiment of the invention.

FIG. 2 is a flow diagram that illustrates a method for controlling a card device in accordance with one embodiment of the invention.

FIG. 3A is a block diagram that illustrates a capabilities list in accordance with one embodiment of the present invention.

FIG. 3B is a block diagram that illustrates a capabilities list in accordance with one embodiment of the present invention.

FIG. 3C is a block diagram that illustrates a capabilities list in accordance with one embodiment of the present invention.

FIG. 4 is a flow diagram that illustrates a method for controlling a card device, including operations to grant or deny access to a resource, in accordance with one embodiment of the present invention.

FIG. 5 is a block diagram that illustrates elements of a card device in accordance with one embodiment of the invention, further illustrating interaction between an application program, a security manager, and a verifier to access a resource.

FIG. 6 is a flow diagram that illustrates a method for controlling access to resources in accordance with one embodiment of the invention, particularly illustrating interaction between an application program, a security manager, and a verifier to access a resource.

FIG. 7 is a block diagram that illustrates elements of a card device according to one embodiment of the invention, illustrating interaction between an application program, a security manager and a verifier to access a resource to access a resource.

FIG. 8 is a block diagram that illustrates a card device, reader, and computing device according to one embodiment of the invention.

### DETAILED DESCRIPTION

Embodiments of the present invention are described herein in the context of card device resource access control. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft® Windows® XP and Windows® 2000, available from Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

In the context of the present invention, the term “network” includes local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In the context of the present invention, the term “fingerprint” is defined as the result of a function that identifies or detects one or more change in a byte sequence. By way of example, a fingerprint may comprise a non-commutative fixed size hash of an arbitrary byte sequence or a non-commutative fixed size hash of a sequence of one or more byte sequences. As a further example, a fingerprint may comprise a checksum, a CRC (cyclic redundancy code), a message digest, or the like. Such functions are described in Knuth, D. The Art of Computer Programming, Volume 2: Seminumerical Methods, Chapter 5. Addison Wesley, 1981.

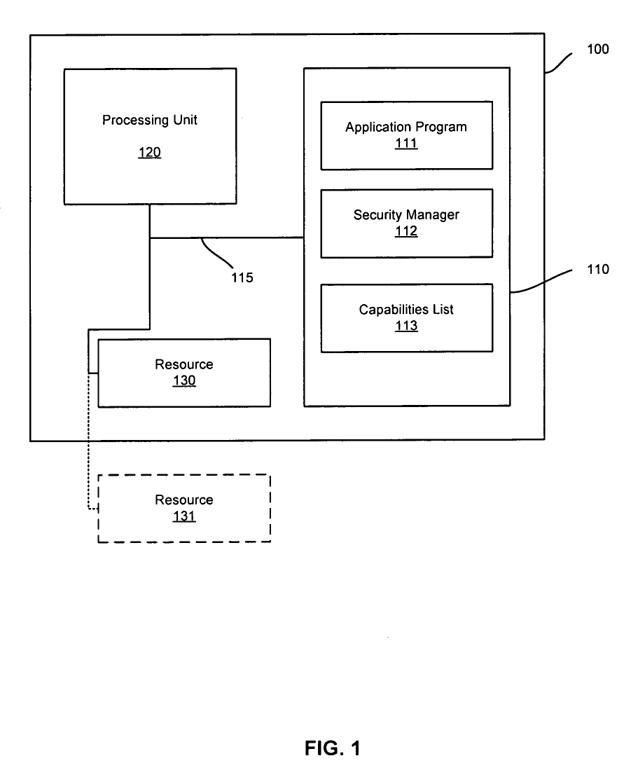

FIG. 1 illustrates elements of a card device enabling improved access to resources and allowing improved maintenance of access rights in accordance with one embodiment of the present invention.

Card device 100 comprises a memory 110. The memory 110 comprises an application program 111, a security manager 112, and a capabilities list 113. Card device 100 also comprises a processing unit 120 and one or more of resource 130 and resource 131. Processing unit 120, memory 110 and one or more of resource 130 and resource 131 are in communication via communication means 115. The resources may be internal resources 130 of the card device 100, i.e. resources only within card device 100, or external resources 131, located external to the card device 100.

Memory 110 is provided for storing the capabilities list 113, the application program 111 and the security manager 112, but may be also used for storing any other kind of data required for operating the card device 100 or other purposes. The capabilities list 113 comprises information regarding access to resources for use by the application program 111, such as information regarding access rights to one or more resources (130, 131). The processing unit 120 is provided for executing the application program 111, such as a service application for providing a user service. The processing unit 120 is also provided for executing the security manager 112. The security manager 112 is provided for selectively granting access to the resources (130, or 131, or both) for use by the application program 111 based at least in part on the capabilities list 113.

Since the capabilities list 113 comprises all information regarding access rights of the application program 111 to the resources, the security manager 112 can examine the capabilities list 113 associated with the application program 111 to determine whether the application program 111 is authorized to perform a requested access.

According to one embodiment of the present invention, the capabilities list 113 is transferred to the card device 100 when loading an application program 111 to the card device 100. The capabilities list 113 may be transferred to the card device 100 before or after the application program 111, or the application program 111 and the capabilities list 113 may form a load package, which can be transferred to the card device 100 in one operation.

Similarly, when an application program 111 is removed from the card device 100, the application program 111 and the capabilities list 113 can be deleted.

Embodiments of the present invention obviate the need to update any access rights which are maintained in association with resources, thus reducing the number of processing operations to add or remove an application program 111.

The card device 100 shown in FIG. 1 will be described in more detail below. The following examples are for purposes of illustration and are not intended to be limiting in any way.

The card device 100 may be any kind of known card device 100, such as a smart card or any other kind of portable device having provided thereon a memory and a processing unit. The card device may be provided for making payments and obtaining services such as in banking applications, health care, transportation, and entertainment.

The card device 100 can be a type of plastic card embedded with a computer chip for storing data and for data transactions between users, such as a customer and a retailer. For example, data stored on the card device 100 may represent a monetary value or information or both, and can be stored in the memory 110 and processed by the microprocessor 120. Generally, the card device 100 can host a file to identify private data and other data associated with a user. The stored data may be accessed and handled by multiple application programs. The card device 100 is controlled via an operating system providing the basic functionalities of the card device 100, similar to an operating system on a desktop computer, workstation and the like.

The card device 100 forms part of a computing system comprising further computing devices for communicating with the card device 100 and further including a reading device for reading and writing data from and to the card device 100 to communicate the data with the further computing devices. The card device 100 can be accessed through the reading device (not shown in FIG. 1) adapted for example for insertion of the card device 100, to connect respective terminals of an input/output unit of the card device 100 with terminals of the reading device. The reading device may form part of a host computer (not shown in FIG. 1) or may be a separate device connected to a computing device or network. In operation, after inserting the card device 100 into the reading device, a user, provided proper authorization, may activate an application program 111 stored on the card device 100. The application program 111 then requests access through security manager 112 to a resource (130, 131). The access request is processed by the security manager 112 and granted based at least in part on the access rights stored in the capabilities list 113.

The memory 110 comprises any known type of card device memory. The memory 110 may be arranged as a separate partition of the card device 100, and may be a magnetic or any other kind of medium for storing data. Alternatively or in addition thereto, the memory 110 may be at least partially realized on the processing unit 120, e.g. as a random access memory, cache or the like.

The processing unit 120 provided on the card device 100 comprises any kind of processing element for card devices, such as a central processing unit for handling all or part of the functionality provided for or by the card device 100. By way of example, the processing unit 120 may comprise a single device provided on the card device 100. Alternatively, the processing unit 120 may comprise multiple processing elements, some of which are provided external to the card device 100, such as in cases where the card device 100 requires external processing capabilities to perform certain operations. External processing support may be required if the computing capabilities of the processing unit 120 are insufficient to perform the operations required for executing the application program 111, the security manager 112 and the like.

FIG. 1 illustrates a resource 130 forming part of the card device 100. Furthermore, in addition to the resource 130 or as an alternative thereto, a resource 131 is shown, which forms a resource being arranged external to the card device 100. Generally, resources 130 and 131 comprise any kind of resources of the card device 100 or external thereto, including data, functions, or both. For example, resources 130 and 131 may comprise data files of a file system on the card device 100. The data files may include, for example, data representing monetary values, or data of a user profile, user data and the like. Moreover, the resources may comprise one or more functions, i.e., functionality provided by or for the card device 100. Any functionality of the card device 100 may be provided via executing programs or program elements on the processing unit 120, where the programs perform certain actions within the card device 100 or external thereto, such as storage operations, data retrieval operations, arithmetic operations, data transmission operations and the like. The resources may also include physical elements of the card device 100 or external thereto, such as communication channels, e.g. a General Packet Radio Service (GPRS) channel or the like.

Accordingly, the resources may include any kind of data fields and software programs, such as objects defined in an object oriented programming language.

According to one embodiment of the present invention, the data fields and objects are defined in a programming environment. By way of example, objects may comprise applets or other Java objects.

The resources may include a terminal side resource, such as a timer or other resources of the operating system or application program of a computing device in communication with the card device 100, and may include channels of a communications network, and the like.

Ownership of a resource refers to one or more entities that control the resource. A resource may be owned by a particular application program 111, an operating system of the card device 100, another application program of the card device 100, or an external entity such as an external application program. More generally, a resource may be owned by any entity of the card device 100 or external thereto, and may be managed by the owning entity. Furthermore, a resource (130, 131), such as a Java object or data files, may be owned by the user, the operator of the card device 100, and similarly by further entities.

As noted above, the card device 100 holds one or more application programs, such as application program 111. Each of the one or more application programs provides a service and, in order to provide the service, access resources on the card device 100 and external thereto, such as resources 130 and 131. An application program 111 can be realized as a software program stored in the memory or on the processing unit and having instructions to carry out, when loaded and executed on the processing unit, a functionality associated with the application program 111. By way of example, application program 111 may provide functionality for making payments and obtaining services such as in banking applications, health care, transportation and entertainment. Application program 111 may be provided as a single program or as a group of interacting programs or program modules.

Alternatively or in addition thereto, application program 111 may be realized at least in part in hardware.

According to one embodiment of the present invention, application program 111 may be defined in the Java programming environment. More particularly, an application program 111 may comprise a Java Card™ applet or a Java application program. Java Card™ technology is described in Chen, Z. Java Card™ Technology for Smart Cards—Architecture and Programmer's Guide, Boston, Addison-Wesley, 2000.

The capabilities list 113 is provided to facilitate managing access to the resources (130, 131) and comprises access information regarding which resources can be accessed by an application program 111. The capabilities list 113 may be organized as a look-up table, listing resources e.g. in a first column and an identifier specifying whether access is allowed or to be denied in a second column. Information regarding an access right can then be retrieved by simply accessing the capabilities list 113, searching for the resource in question and reading the associated access information. The capabilities list 113 may be provided in the form of a data file associated with the application program 111 or may form a part or an integral part of the application program 111.

In addition to the binary information allowing or denying access to a resource, the capabilities list 113 may also include information regarding the type of accesses which may be carried out by the application program 111, such as read access, both read access and write access, access rights to a General Packet Radio Service (GPRS) channel, or an access right to certain limited number of GPRS channels.

Still further, the capabilities list 113 may include information required for access to a resource, such as an authorization or authentication scheme, a type of PIN required, and the like.

In addition to the above information, or in an alternative thereto, the capabilities list 113 may also include a handle to another capabilities list associated with another application program, such as where the access rights of different application programs are similar or identical. The handle may comprise link information, an identifier of the other capabilities list 113, a path in a file tree structure leading to the other capabilities list, or any combination thereof. Thus, when an application program 111 requires access to a resource (130, 131), the security manager 112 uses the handle to access the capabilities list of the other application program to retrieve the actual information regarding the access rights. Multiple handles may lead to the capabilities list 113 which physically stores the access rights to the resources.

According to one embodiment of the present invention, the capabilities list 113 is embodied in a Tag-Length-Value (TLV) structure, including an identification of the application program 111 or an applet instance. TLV structures are described in ISO/IEC 8824:1998, Information technology—Open Systems Interconnection—Specification of Abstract Syntax Notation One (ASN.1), and ISO/IEC 8825: Information technology—Open Systems Interconnection—Specification of Basic Encoding Rules for Abstract Syntax Notation One (ASN.1), both available from the International Organization for Standardization (ISO).

According to another embodiment of the present invention, the capabilities list 113 is defined using XML (Extensible Markup Language).

As noted above, the security manager 112 is responsible for examining the capabilities list 113 and for obtaining information regarding resource access rights. The security manager 112 can be any kind of software program which handles resource access requests from one or more application programs, by examining the capabilities list 113 in order to determine whether the access requesting application program 111 has a valid access right.

The security manager 112 may form a separate program, handling access requests from multiple application programs. Alternatively, the security manager 112 may form part of one or each of multiple application programs on the card device 100. The security manager 112 may also include multiple sub-modules for handling specific tasks for obtaining information regarding an access right, such as identifying a requesting application program 111, identifying a capabilities list 113, retrieving information from an identified capabilities list 113, and the like. Alternatively or in addition thereto, the security manager 112 may be realized at least in part in hardware.

While FIG. 1 shows a single security manager 112, multiple security managers may be present, e.g. in association with an application context, an applet context, an operating system, etc.

A program or programs may be provided having instructions adapted to cause the processing unit or a network of data processing devices to realize elements of the above embodiments and to carry out the method of at least one of the above operations. Furthermore, a computer readable medium may be provided, in which a program is embodied, where the program is to make a computer execute the method of the above operation.

Also, a computer-readable medium may be provided having a program embodied thereon, where the program is to make a card device 100 execute functions or operations of the features and elements of the above described examples. A computer-readable medium can be a magnetic or optical or other tangible medium on which a program is recorded, but can also be a signal, e.g. analog or digital, electronic, magnetic or optical, in which the program is embodied for transmission. Furthermore, a data structure or a data stream may be provided including instructions to cause data processing means to carry out the above operations. The data stream or the data structure may constitute the computer-readable medium. Still further, a computer program product may be provided comprising the computer-readable medium.

In the following, for further illustration of the invention, an example of using the card device 100 for purchasing goods will be described.

An owner of the card device 100, desiring to purchase an article, for example in a shop or via the Internet, introduces a card device 100 into a card reader, as noted before.

The card device 100, for the purpose of the purchase, holds data corresponding to a monetary value of funds available on the card device 100. Furthermore, the card device 100 holds an application program 111 for communicating with an external computing device, in order to deduct an appropriate amount from the funds available on the card device 100.

In the process of the purchase the processing unit, such as the processing unit 120 of FIG. 1, executes the purchase application program, such as the application program 111 shown in FIG. 1, and receives an instruction from an external device through the card reader, to deduct an appropriate amount from the funds available on the card device 100. In responding to this request to reduce the funds the application program 111 requires access to resources, such as a data file including an indication of the funds available on the card device 100. The application program 111 thus requests access to the funds data file and transmits a corresponding request to a security manager, such as security manager 112 shown in FIG. 1.

The security manager 112 then accesses a capabilities list 113 associated with the purchasing application program, in order to inquire whether the purchasing application program is authorized to access the funds data file. Assuming proper operations, the purchasing application program will be authorized to access the funds data file and the security manager 112 will carry out the required deduction of funds.

In an alternative to the above separate arrangement of the application program 111 and security manager 112, if the purchasing application program and the security manager 112 form a single program, the capabilities list 113 can be directly inquired and an access can be carried out in response to the inquiry result.

After deducting an appropriate amount from the funds available on the card device 100, an acknowledgement message may be transmitted to the external computing device and the transaction could be completed.

As illustrated above, since the purchasing application program has associated therewith a capabilities list 113, access to resources such as the funds data file can be facilitated. It is no longer necessary to inquire about access rights in association with each resource, such as the funds data file, indicating that an application program 111 such as the purchasing application program is authorized to access the funds data file.

Also, adding an application program 111 to the card device 100 or removing an application program 111 from the card device 100 requires only to add, update or remove the corresponding capabilities list 113.

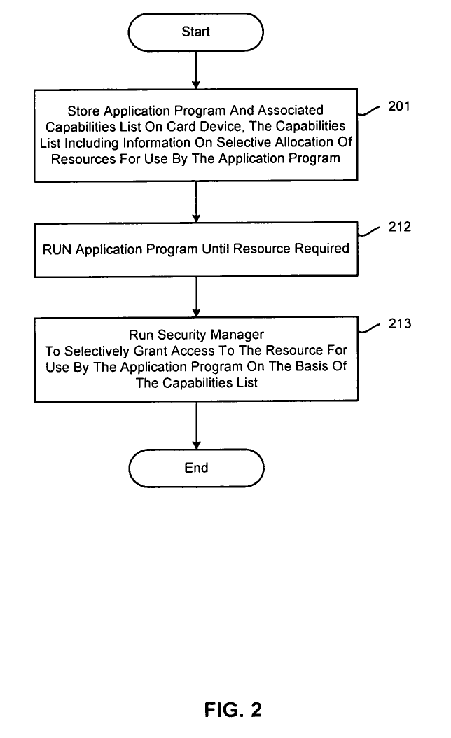

Turning now to FIG. 2, a flow diagram that illustrates operations of a method for controlling a card device and for controlling access to resources in accordance with one embodiment of the present invention is presented. The operations of FIG. 2 may be carried out in association with the card device illustrated in FIG. 1. However, FIG. 2 is not limited thereto.

At 201 an application program and a capabilities list associated with the application program are stored on the card device, in a memory or processor provided on the card device. As before, the capabilities list comprises information regarding selective location of resources for use by the application program, and can be stored together with the application program or at a separate location. An association between the application program and the capabilities list may include a reference or an identifier of the application program and capabilities list, stored with the capabilities list and application program, respectively. An association can also be established via corresponding identifiers of the application program and capabilities list. For example, a corresponding identifier may comprise a memory address or an object reference.

The information regarding access to resources may include information regarding which resources can be accessed by the application program. The information regarding access to resources may also include the extent to which resources can be accessed by the application program. By way of example, the application program may be authorized only for a read operation in association with one resource, e.g. a data file, but may be authorized to read and write data to another resource, e.g. another data file. Similarly, the application program could have authorization to access a communication channel of the card device or an external communication channel. Additionally or in the alternative, the application program may have the right to make use of certain system functionality, such as of an operating system or resources owned by another application program.

Still referring to FIG. 2, at 202 the application program is executed until the continued execution of the application program requires access to one or more resources. Access to a resource can be required during normal execution of the application program, e.g., if data files need to be accessed, information needs to be transmitted, processed or the like.

Upon requiring access to a resource, the application program requests a security manager to further handle the access request to the resource. At 213 the security manager is executed, in order to selectively grant access to the resources for use by the application program. To grant or deny access, the security manager makes use of the capabilities list, i.e., looks up an access right to a specified resource, as noted before.

The security manager may, depending on the determination result, perform the access to the resource and carry out the required operation, such as transmitting data, retrieving data and the like, as noted above, or may return to the application program an authorization to directly access the resource.

Accordingly, access from application programs to resources can be conveniently organized by examining capability lists that include information regarding access rights.

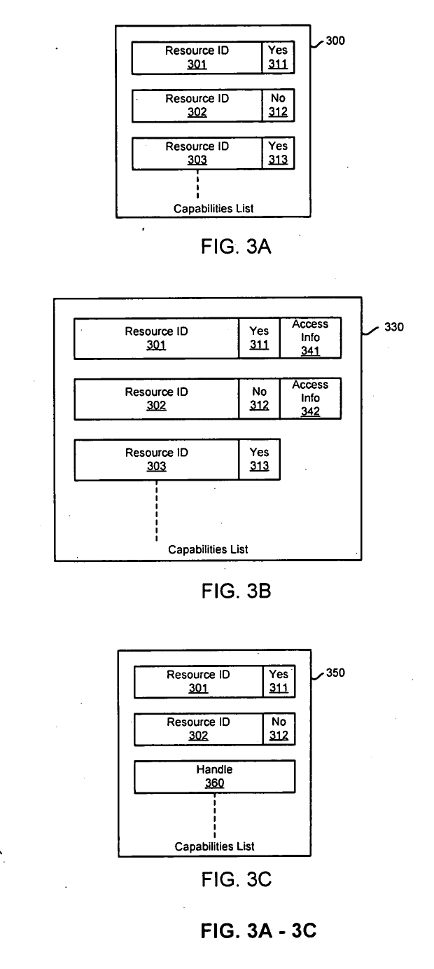

In the following, additional embodiments of the present invention will be described with regard to FIGS. 3A-3C. FIGS. 3A-3C illustrate embodiments of a capabilities list for use in accessing resources in accordance with embodiments of the invention

FIG. 3A shows a first embodiment of a capabilities list 300, for accessing resources 301, 302 and 303.

The capabilities list 300 may be a data file for storage in a memory of a card device or in any other form, as described above. The capabilities list 300 may be stored in any known format, including an encrypted format. The capabilities list 300 may include an identifier of an application program to which it belongs. Alternatively, the capabilities list 300 may be stored as appendix to the application program.

As illustrated in FIG. 3A, the capabilities list 300 stores access information regarding resources 301, 302 and 303. According to one embodiment of the present invention, the capabilities list 300 only stores identifiers of the resources 301, 302 and 303. The resources may be any kind of resource, as outlined before, including data, functions, or both. For example, if the resource 301 is a data file, the capabilities list 300 may store a reference to this data file, such as a file name or a path to access the file in a file system. Furthermore, if the resource, e.g., resource 302, represents a function, the capabilities list may store a corresponding identifier of a program for handling the function, or of hardware elements for handling the function, such as an address of a communication channel and the like.

Furthermore, the capabilities list 300 stores in association with each resource identifier (301, 302, 303) an indication (311, 312, 313) showing whether the application program owning the capabilities list is allowed to access the resources. In the examples shown in FIG. 3A, the capabilities list 300 indicates as shown at 311, that access to resource 301 is allowed. The capabilities list 300 also indicates that access to the resource 302 is not allowed, as indicated at reference numeral 312. The capabilities list 300 also indicates that access to the resource 303 is allowed, as indicated at 313.

In operation, the application program requiring access to a resource, through the security manager, examines the capabilities list 300 in order to determine whether access to the resource is allowed. Then the application program either carries out the corresponding access operations or refrains from doing so, based at least in part on whether the capabilities list 300 indicates such access is allowed.

Since card devices are usually physically protected from tampering, i.e. are tamper resistant, it is at least difficult to gain access to an application program, capabilities list 300, or both, in a fraudulent attempt to modify any given access rights. However, in order to further increase a security level, in according to another embodiment of the present invention, the capabilities list is digitally signed, e.g. using the RSA (Rivest-Shamir-Adleman) public key cryptosystem or any other system for cryptographic authentication. In addition or as an alternative thereto, a data encryption method can be used to further protect the capabilities list 300 from fraudulent access, such as according to the Triple DES (Data Encryption Standard) standard or any other data encryption standard. The cryptographic securing, authentication, or both, of the capabilities list 300 may be performed under control of an entity owning the resources specified by the capabilities list 300 or by an owner of the application program, by an operator of the card device or any other entity.

According to another embodiment of the present invention, multiple capabilities lists are associated with a single application program. By way of example, there may be one capabilities list for each group of resources owned by a particular entity. Thus, resources owned by an operating system could be covered by a first capabilities list, whereas resources owned by the user, an application program, or both, could be covered by a second capabilities list. In this case, gaining access to a resource also comprises determining the capabilities list, which stores the access right to the resource. A determination of the appropriate capabilities list may be made in association with the type of resource to be accessed, e.g. by looking up a table associating resources with capabilities lists.

According to another embodiment of the present invention, a single capabilities list may be associated with multiple application programs, e.g. a group of application programs having the same access rights.

In the following, another capabilities list in accordance with one embodiment of the present invention will be described with regard to FIG. 3B.

FIG. 3B illustrates a capabilities list 330, similar to the one of FIG. 3A. The capabilities list 330 again stores resource identifiers of resources 301, 302 and 303, as noted before. Again, the resources may be any kind of data, functions, or both. Furthermore, there is again stored an indication in association with each resource indicating whether the associated application program is allowed to access the resource. Again, it is assumed that the application program holds an access right to the resource 301, as shown at 311, is not allowed to access resource 302, as shown at 312, and again is allowed to access resource 303, as shown at 313.

In addition to the above information, further access information is stored in association with the resources 301 and 302. More specifically, there is stored further access information 341 in association with resource 301, and access information 342 in association with resource 302. The access information 341 and 342 comprises further information regarding access rights, such as information required to perform an access to the resource, including a type of required authorization, authentication, or both, a type of PIN or password required, access codes and the like. Moreover, the access information can include information regarding the type of access allowed, as noted above, such as read access, both read and write access, access to a communication channel or a number of communication channels, including data rates allowed and the like.

According to one embodiment of the present invention, if further access information is present in association with a resource, the access to the resource is determined by this additional access information. And if further access information is absent, it is indicated that unlimited access to the resources is allowed, as this would be the case for resource 303.

In the following, another capabilities list in accordance with one embodiment of the present invention will be described with regard to FIG. 3C.

FIG. 3C illustrates a capabilities list 350, again including resource identifiers 301 and 302 and corresponding indications regarding whether the application program is allowed to access the resource, as it was described with regard to FIG. 3A. In addition to the information regarding whether access is allowed (311) or denied (312), further access information may be provided, as described with regard to FIG. 3B. In addition to the elements shown in FIGS. 3A and 3B, the embodiment of FIG. 3C comprises a handle 360, such as link information, connecting to another capabilities list of another application program, as outlined with regard to previous embodiments. For example, the handle may include an identifier of the further capabilities list, or may include a path required for accessing the further capabilities list. In addition thereto, the handle could also include further information required to access the further capabilities list, such as information required for decrypting the further capabilities list, access codes, and the like.

Thus, the capabilities list can include direct information resource access rights, or may include a handle that provides a link to a further capabilities list that includes the required access information, or a further link to a still further capabilities list, until the required information regarding access rights can be identified.

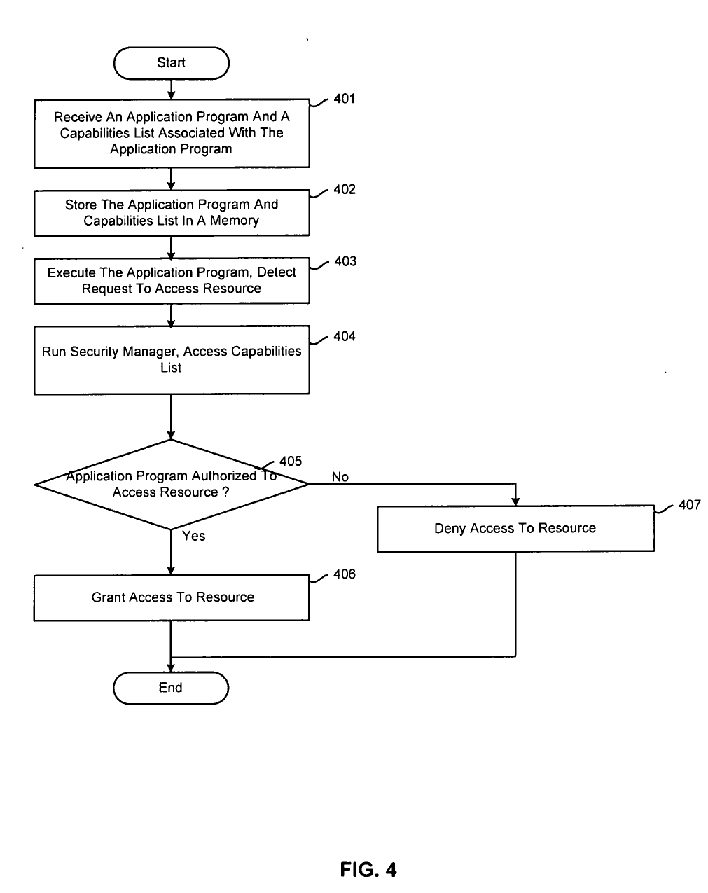

Turning now to FIG. 4, a flow diagram that illustrates a method for controlling a card device, including operations to grant or deny access to a resource, in accordance with one embodiment of the present invention is presented. The operations of FIG. 4 may be carried out using the card device shown in FIG. 1. However, FIG. 4 is not limited thereto.

At 401 an application program and a capabilities list associated therewith are received at the card device. By way of example, the application program may be transferred to the card device in response to a user request, such as when the user wishes to make use of a service or functionality provided by the application program. Furthermore, the application program may be transferred to the card device upon an instruction under the control of an operator of the card device, e.g., in order to add functionality to the card device. According to one embodiment of the present invention, the application program and the associated capabilities list are transferred together in a single load package. According to further embodiments of the present invention, the application program and the associated capabilities list are transmitted as separate data elements, either simultaneously or at different times.

The above transfer of the application program to the card device can for example be carried out by making use of a card reader with the card device inserted therein, as detailed above, and a transfer of the application program and capabilities list may be carried out in accordance with any known protocol to transfer information to and from card devices, as known in the art, including wireless transmissions.

Upon receiving the application program and the capabilities list, at 402, the card device stores the capabilities list and the application program in a memory on the card, also as outlined before. Further operations may precede or follow the storage of the application program, in order to enable the user to make use of the application program, such as installation operations, compilation operations and the like.

After transferring the application program to the card device, the user or another entity may wish to make use of the functionality provided by the application program. At this time, the application program is run, e.g. on the processing unit 120 shown in FIG. 1. Running the application program may take place by loading corresponding program code into the processing unit and executing the program code, as appropriate. During execution, a request to access a resource is detected at 403. The request to access a resource will occur, e.g. if data needs to be read, written, transferred, processed and the like, or if certain functionality should be invoked.

Upon detecting such a resource access request, at 404 the services provided by the security manager are invoked and the security manager accesses the capabilities list to (1) inquire whether the application program is authorized to make use of the resource, (2) inquire to which extent the application program is authorized to make use of the resource, or both.

The security manager may for example be a program element called by the application program upon the occurrence of the necessity to access a resource. Alternatively, the application program and the security manager may be integrally formed, in which case the capabilities list can be directly accessed, if access to a resource is required.

At 404 the security manager detects whether the application program is authorized to access the resource as requested.

If at 405 the decision is “YES”, i.e., if the application program is authorized to access the resource, at 406 access to the resource is granted. Granting access to the resource may include transmitting an indicator to the application program showing that the application program is allowed to make access to the resource as required, or may include transmitting an indicator to the application program indicating to what extent the application program is authorized to access the resource. Alternatively or in addition thereto, the security manager may handle the access to the resource, and may return an access result to the application program, such as data of an accessed file, information regarding operations and functions carried out and the like.

If at 405 the decision is “NO”, indicating that the application program is not authorized to access the resource, at 407 access to the resource is denied. Denying access to the resource may include transmitting a corresponding message to the application program, or triggering error processing. Denying access to the resource may also include notifying the owner of the resource, the user or operator of the card device, or both, regarding the denial of access.

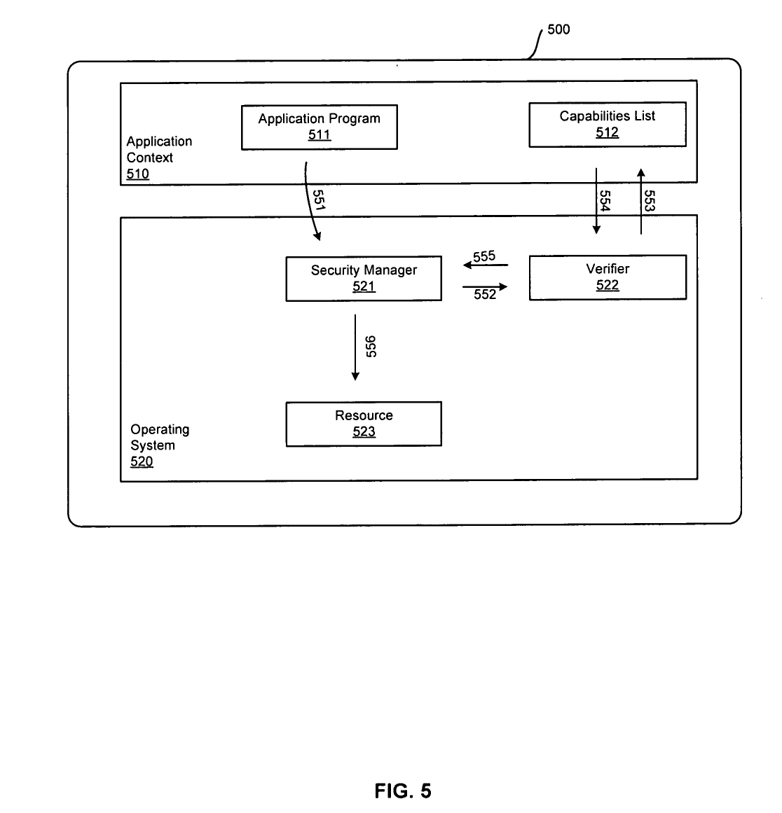

Turning now to FIG. 5, a block diagram that illustrates elements of a card device in accordance with one embodiment of the invention, further illustrating interaction between an application program, a security manager, and a verifier to access a resource is presented. In FIG. 5, a card device is generally shown at 500 and comprises an application context 510. The application context 510 comprises an application program 511 and a capabilities list 512. The application context 510 is, seen on an operational level, an operational (not physical) area of the card device 500 occupied by the application program 511 and the capabilities list 512. Defining an application context 510 allows maintaining a clear distinction between elements belonging to an application program 511 and elements of the card device 500 belonging to further entities.

The card device 500 also comprises an operating system 520, constituting an operational (not physical) area, again in an operational sense, required for performing the basic operation and functionality of the card device provided by the operating system. The operating system 520 hosts or includes a security manager 521, a verifier 522 and a resource 523.

In FIG. 5 it is assumed that an application program wishes to access a resource located in the operating system.

The security manager 521 receives a request to access a resource 523 from an application program 511. The security manager 521 may communicate with the application program 511 through an application program interface (API), facilitating placing a resource access request to the security manager. The application program interface may form part of the security manager or may constitute a separate entity of the operating system 520.

The operating system 520 also comprises a verifier 522 configured to determine whether the application program 511 is allowed to access the resource 523, upon request from the security manager 521. The verifier 522 examines the capabilities list 512 available in the application context 510 to determine whether access should be allowed or denied. Based on the determination result the security manager 521 then grants or denies access to the resource 523.

In the present example the resource 523 is shown to form a part of the operating system 520. However, the resource may be located elsewhere. The resource may be owned by another application program, placed in another application context, or available external to the card device 500.

In operation, i.e., when running the application program 511, when access to resource 523 is required, application program 511 transmits a resource access request 551 to the security manager 521. The resource access request 551 may include information regarding the identity of the application program 511, and the resource to be accessed. Additionally, the request may include information regarding the type of access required.

Alternatively, if the resource access request does not include information regarding the requesting application program, the security manager 521 may perform a look-up operation in order to determine an origin of the resource access request. For example, the security manager 521 may determine from which application context the resource access request emerged.

Thereafter, in an operation illustrated by arrow 552, the security manager 521 requests from the verifier 522, information regarding whether the resource 523 can in fact be accessed. This request may include information regarding the requesting application program, the resource to be accessed and, if applicable, the type of access required. Based on the information provided, the verifier 522 determines the appropriate capabilities list 512, as indicated by arrow 553, and obtains information 554 regarding (1) whether access to the resource is allowed, (2) to what extent access to the resource is allowed (554), or both. If the application context 510 includes multiple capabilities lists associated with the application program 511, the verifier may determine an appropriate capabilities list 512 based at least in part on the resource 523, such as based on ownership of the resource 523, through a lookup table or the like.

Thereafter, the verifier 522 returns to the security manager 521 an indication regarding whether access to the resource 523 is allowed or denied (555).

In response to this indication the security manager 521 carries out the access to the resource 523, as indicated by arrow 556. In other words, the security manager 521 performs the access to the resource 523 on behalf of the application program 511. Alternatively, the security manager 521 in a subsequent step may authorize the application program 511 to carry out the access to the resource 523 itself.

According to one embodiment of the present invention, the operating system 520 comprises the Java Card™ Runtime Environment (JCRE). The JCRE constitutes an operating run-time environment or part of an operating system for card devices allowing card device operation in the Java programming environment. In this case, application programs may for example be Java objects, and resources may be represented as any kind of further Java elements or data, as noted before. Accordingly, resources may be part of the JCRE or of the operating system, e.g. such as a file system object.

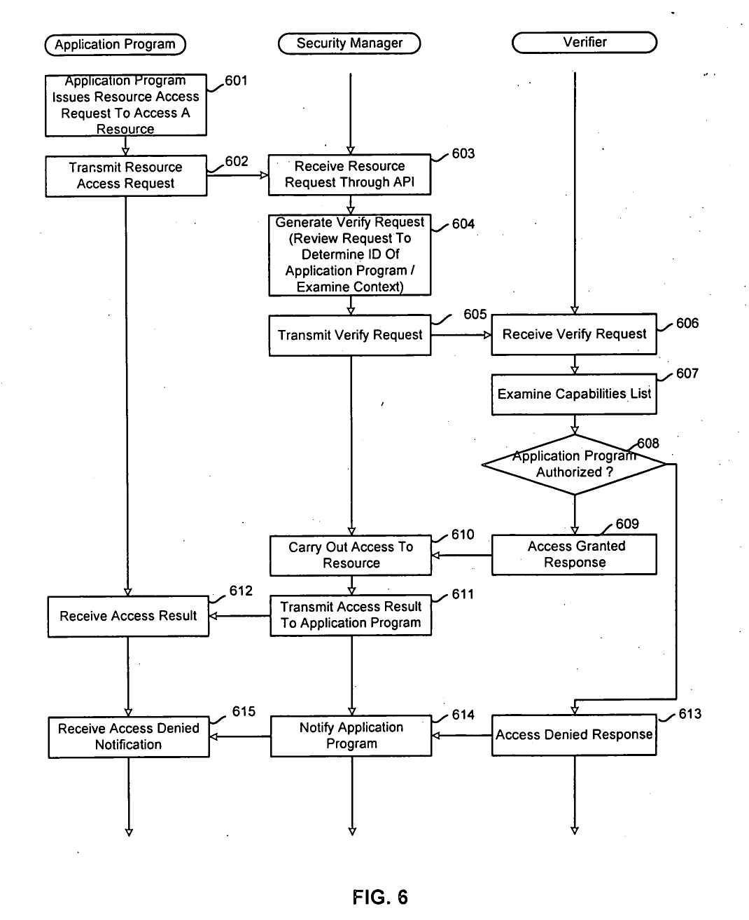

Turning now to FIG. 6, a flow diagram that illustrates a method for controlling access to resources in accordance with one embodiment of the invention, particularly illustrating interaction between an application program, a security manager, and a verifier to access a resource is presented. FIG. 6 illustrates in detail the operations carried out by an application program, a security manager and a verifier, for example in the device of FIG. 5. However, FIG. 6 is not limited thereto.

As outlined with regard to previous embodiments, the application program may be any kind of application program for a card device, such as a banking application, a healthcare application, an entertainment application, or the like. According to one embodiment of the present invention, the application program comprises a Java Card™ applet, e.g., if the card device is operated under the JCRE (Java Card™ runtime environment).

The security manager may have a functionality similar to the security manager described earlier, and may be constituted by a program for execution on the card device, and for managing the access to resources upon request by the application program. According to one embodiment of the present invention, the security manager forms part of an operating system of the card device, such as part of the JCRE. According to another embodiment of the present invention, the security manager forms part of an application context, i.e. may be associated with the application program, or be integrally formed therewith.

According to one embodiment of the present invention, the verifier comprises a program for execution on the card device. The verifier may form part of an operating system of the card device, such as the JCRE, but may also be located elsewhere. The verifier is generally responsible for examining capabilities lists, in order to determine whether resource access is to be allowed or denied.

The application program, the security manager and the verifier may be entirely realized in software. It is also possible that the application program security manager and verifier may be realized at least in part in hardware.

Transmissions between the application program, the security manager and the verifier may be carried out through internal communication lines of the card device, e.g. using function calls, communication protocols and the like, as known in the art.

Referring to FIG. 6, at 601 the application program issues a resource access request to access a resource, such as outlined before. The resource access request, in an example, is dynamically generated by the application program upon reaching an execution state where access to a resource is required. In the above example of purchasing goods, a resource access request is issued if funds stored on the card device, e.g. in a funds data file, need to be modified. The resource access request may include an identifier of the resource to be accessed, such as an identifier of the resource or a path in a file tree for accessing the resource. In addition thereto, the resource access request may include an identifier of the issuing application program. Alternatively, information regarding the requesting application program is not included in the resource access request and retrieved at a later point in time. Furthermore, the resource access request may include information regarding an access type requested to the resource, such as which kind of access is required, as noted above.

At 602 the resource access request is transmitted to the security manager, where it is received at 603. In one example, the resource access request is received through an API (Application Program Interface) provided at the security manager. Making use of an API is particularly advantageous if multiple application programs are present on the card device and if clearly defined and structured access to the security manager is required.

At 604 the security manager generates a verify request, to obtain information regarding authorization of the application program to access the resource. The security manager acts on behalf of the application program and therefore realizes the functionality of a proxy, the advantage thereof being that the application program needs to interact with only the security manager, i.e. with the API of the security manager, and that the application program therefore only is required to maintain knowledge on an access procedure to the security manager through the API. Hence, application programs may be designed under consideration of only the structure of the API, but independent of the remaining configuration of the card device.

If the resource access request included information regarding the requesting application program, the verify request can be readily generated, including information regarding the resource to be accessed and on the identity of the application program requesting the resource access.

If the resource access request does not include information regarding the requesting application program, the security manager investigates the identity of the requesting application program. According to one embodiment of the present invention, the security manager transmits a capabilities list examination message to an application context originating the resource access request, e.g. by determining the application program context from an address section of the resource access request.

In response to the capabilities list examination message, the application context determines the requesting application program and returns the determination result to the security manager. Using Java Card™ technology as an example, a Java Card™ technology-enabled device determines the requesting application program, by requesting the previous applet context.

According to another embodiment of the present invention, the security manager examines a central registry based at least in part on identification information in the resource access request, in order to determine the identity of the requesting application program.

After the identity of the requesting application program is obtained, the verify request can be generated and, at 605, the verify request is transmitted to the verifier, where it is received at 606.

At 607, the verifier determines a capabilities list, based at least in part on the identity of the application program and the resource to be accessed. The capabilities list may be associated with the requesting application program, or the capabilities list may belong to another application program linked to the requesting application program, as outlined before. The capabilities list is then examined in order to determine whether the application program is authorized to access the resource.

Furthermore, if the resource access request included information regarding the type of access requested, the verifier may also determine whether the requested type of access is to be allowed or is to be denied.

Examining the capabilities list is carried out by accessing the capabilities list and determining a portion of the capabilities list indicating an authorization of the application program in view of the resource.

According to embodiments of the present invention, the capabilities list may be encrypted, cryptographically signed, or both. If the capabilities list is encrypted, examining the capabilities list includes the application of appropriate decryption programs. This may entail obtaining a proper decryption key from an owner of the application program, or of an owner of the resource, and using the processor of the card to perform the corresponding decryption operations.

If the capabilities list is cryptographically signed, it may be signed by one or more of the provider of the application program and the owner of the resources. Additionally, examining the capabilities list includes cryptographically authenticating the capabilities list. This may entail using a proper authentication key from an owner of the application program, or of an owner of the resource, and using the processor of the card to perform the corresponding authentication operations.

According to one embodiment of the present invention, the authenticity of a capabilities list is established using any known authentication mechanism when the capabilities list is ready for storage on the card device. If authentication of the capabilities list is successful, the capabilities list is stored on the card device and may be accessed subsequently without further authentication. If authentication of the capabilities list is not successful, it is not stored on the card device.

According to another embodiment of the present invention, the authenticity of a capabilities list is established at runtime when the capabilities list is accessed. When the capabilities list is stored, it is stored together with a first fingerprint that is computed over the capabilities list. When the capabilities list is referenced at run-time, a second fingerprint is computed over the capabilities list and compared to the first fingerprint that was stored together with the capabilities list. If the two fingerprints match, the authenticity of the capabilities is established and may be used to determine access to one or more resources. According to one embodiment of the present invention, computation of the second fingerprint and comparing the first and second fingerprints occurs each time a capabilities list is used. According to another embodiment of the present invention, computation of the second fingerprint and comparing the first and second fingerprints occurs when the corresponding capabilities list is first used, and a flag is set to indicate whether the two fingerprints matched. The flag is referenced upon subsequent uses of the capabilities list.

Referring again to FIG. 6, at 608 a determination is made regarding whether the application program is authorized to access the resource. If the application program is authorized to access the resource, at 609 an access granted response is returned to the security manager. At 610, the access granted response is received and the access to the resource is carried out accordingly. Again, the security manager acts on behalf of the application program, by carrying out the access to the resource as requested by the application program.

Alternatively, the security manager or the verifier may transmit an access granted response to the application program in order to enable the application program to directly perform the resource access.

Any resource access result obtained at 611 is transmitted to the application program. At 612 the access result is received. An access result may include any kind of data retrieved, processing result, or acknowledgement of transmission of data and the like.

If at 608 the application program is not authorized to perform the access to the resource or to the extent requested, at 613 an access denied response is transmitted to the security manager. At 614 the access denied response is received. The security manager then notifies the application program, and at 615 the application program receives the access denied notification.

In addition thereto, error handling may be performed. For example, an owner of the resource and/or of the application program or an operator of the card device may be notified regarding the denial of access, in order to take appropriate action.

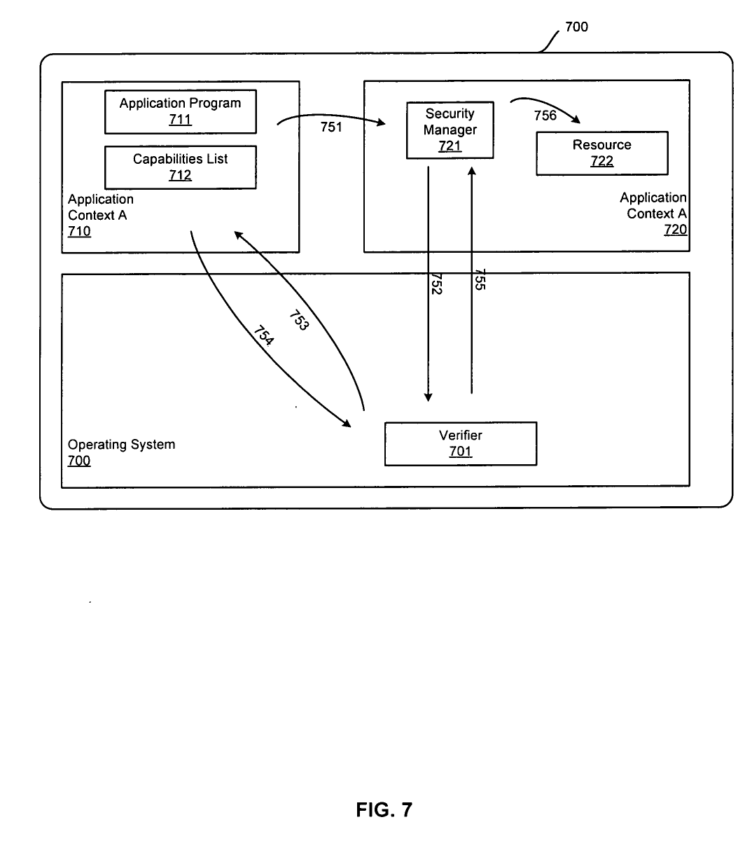

Turning now to FIG. 7, a block diagram that illustrates elements of a card device according to one embodiment of the invention, illustrating interaction between an application program, a security manager and a verifier to access a resource to access a resource is presented. FIG. 7 shows elements of a card device for communication with an electronic device. As shown in FIG. 7, the card device comprises a first application context 710, a second application context 720, and an operating system 700.

The embodiment of FIG. 7 illustrates an example where an application program requests access to a resource located in another application context, i.e., a resource owned by another application program.

The first application context 710 comprises an application program 711 and a capabilities list 712. The application program 711 and capabilities list 712 are substantially as outlined before, i.e., the application program 711 may be any kind of card device application program, and the capabilities list 712 comprises information regarding an authorization of the application program 711 to access resource of the card device 700 or external thereto.

The second application context 720 comprises a security manager 721 and a resource 722. The security manager 721 may be substantially as outlined with regard to previous embodiments, i.e. may be responsible for acting on behalf of an application program to carry out an access to a resource. The resource 722 of the second application context 720 may be any kind of resource located in the second application context 720, such as a data file, a function of the second application context 720 and the like.

As an alternative or in addition thereto, the resource 722 may be at least partially located outside the second application context 720, including outside the card device, as noted before.

The operating system 700 of FIG. 7 is also substantially as outlined with regard to previous embodiments, i.e., constitutes an operating system of the card device, such as the JCRE or any other operating system of a card device. The operating system 700 comprises a verifier 701, substantially as outlined with regard to previous embodiments, i.e., responsible for interacting with security managers in order to determine whether access to a resource should be allowed or denied.

The application program 711 at some point during execution requires access to the resource 722 located in and/or owned by the second application context 720. Since the resource is not owned by the application program 711, the application program 711 must determine whether it is authorized to access the resource.

Thus, the application program 711 requests access to the resource via the security manager 721, as illustrated by arrow 751. The application program, knowing which resource is to be accessed, can determine an appropriate security manager. In the present case, security manager 721 is the appropriate security manager because security manager 721 belongs to the same application context 720 as the resource 722.

The security manager 721, in response to receiving the request from the application program 711, and, e.g. after determining the identity of the requesting application program, sends a verify request to the security verifier 701 of the operating system 700, as indicated by arrow 752.

The verifier 701, in response to receiving the verification request, determines the capabilities list 712 in question, i.e., the capabilities list associated with the application program 711, and determines by accessing the capabilities list 712, whether the application program 711 in fact is authorized and, e.g., to which extent the application program is authorized to access the resource 722, as indicated by arrows 753 and 754.

Based on the determination result, the verifier 701 notifies the security manager 721 whether access to the resource should be allowed, and the extent to which access to the resource should be allowed, as indicated by arrow 755.

The security manager 721 then carries out the access to the resource on behalf of the application program based on the notification from the verifier 701.

While FIGS. 5 and 7 show one exemplary security manager, it is understood, that multiple security managers may be provided, e.g. for application programs and the operating system, in a one-to-one association with each application program and the like. Furthermore, while FIGS. 5 and 7 show one exemplary verifier, multiple verifiers may be provided.

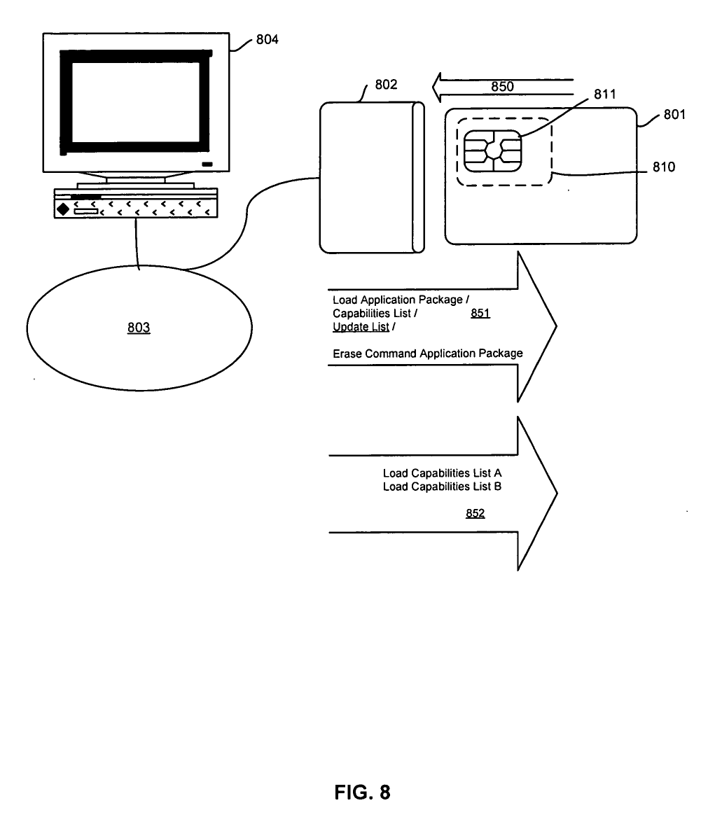

Turning now to FIG. 8, a block diagram that illustrates a card device, reader, and computing device according to one embodiment of the invention is presented. FIG. 8 also illustrates interactions within the computer system in view of loading/erasing application programs to/from the card device and managing resource access from application programs on the card device to resources on or external to the card device.

FIG. 8 illustrates a card device 801, to be inserted into a card reader 802 as illustrated by arrow 850. Card reader 802 is connected to a network 803, such as a packet switched computer network or any other network. Alternatively, the card reader 802 may also be directly connected to a computing device. Furthermore, the system of FIG. 8 illustrates an exemplary computing device 804 for controlling and maintenance of the card device, e.g. a computing device of an operator of the card device.

The card device 801, as in previous embodiments, may be any card device such as a smart card or any other portable device having an embedded memory section for storing a capabilities list associated with an application program, where the capabilities list comprises information regarding access to resources for use by the application program, and further for storing the application program, and a security manager, as detailed with regard to previous embodiments of the present invention. Moreover, the card device 801 comprises a processing unit for executing the application program and the security manager for selectively granting access to the resources for use by the application program based at least in part on the capabilities list. The memory for storing the capabilities list, the application program and the security manager, and the processor are schematically shown at reference numeral 810. The card device 801 further comprises a set of terminals 811 for external access, while the remaining elements of the card device are sealed in a plastic casing. The card device 801 may be in one of various available formats such as in the size of a credit card or in the size of a SIM (Subscriber Identification Module) in the GSM system (Global System for Mobile Communication).

The card reader 802 comprises any kind of reading device for connecting to the terminals 811 of the card device 801, in order to access the card device 801 for communication therewith or data transactions between the card device 801 and the remaining part of the computing system shown in FIG. 8. Card readers are well known in the art, and include reading devices provided in shops, telephones, money teller machines, and personal reading devices of a holder of the card device, such as a mobile phone, PDA (Personal Digital Assistant) and the like.

The network 803 shown in FIG. 8 comprises any kind of communication facility for interconnecting the elements of a computing system such as the reader 802 and the computing device 804, or any other computing devices forming part of the computer system, e.g. a computing device of a retailer of goods, of a health care institution and the like. The network may be a packet switched network or any other network having dedicated communication lines or combinations thereof.

The computing device 804 comprises a general purpose computing device or any other kind of computing device or group of computing devices. The computing device 804 further is equipped with required software for accessing the computing card once inserted into the card reader 802, in order to be able to perform communications with the card device 801, including transfer and reading of data. The computing device 804 may be owned by the operator of the card device 801 for any other entity wishing to communicate with the card device 801.

In the following example, it is assumed that a new application program should be transferred to the card device for enhancing or modifying the services provided by the card device. Such application program could, for example, include functionality to maintain monetary funds on the card device, in order to purchase goods.

According to one embodiment of the present invention, the application program, e.g. in the form of an application package, is loaded to the card device 801 through the reader 802 from the computing device 804, to be stored in a memory on the card device 801. Furthermore, a corresponding capabilities list, associated with the application program, is transferred to the card device, e.g. by the owner of the application program or the owner of a particular resource or group of resources. The capabilities list is also stored on the card device and appropriately handled together with the application program, as outlined with regard to previous embodiments.

In another example the application program and the capabilities list are already available on the card device, but a new resource was added to the resources available on the card device or external thereto, e.g. by downloading a new application program. Alternatively, authorizations may have been modified after transferring the application program and capabilities list to the card device. In these cases it is advantageous to transmit an update list to the card device, instead of an entire capabilities list, the update list for updating an existing capabilities list of at least one of the application programs on the card device. An operating system of the card device 801 then performs the update operations to update the capability list or lists on the card device, as required. From a physical point of view, the processor of the card device will perform the necessary operations for modifying the capabilities list based at least in part on a subsequently received capabilities update list associated with the application program.

Accordingly, access to resources on or external to the card device can be conveniently controlled by making use of capabilities lists in association with application programs, where the capabilities lists include all information required to determine an authorization of an application program giving access to a resource.

Likewise, when an application program is to be removed from the card device, an erase command is transmitted to the card device via the reader 802, e.g. from an owner of the application program or an operator of the card, and in response thereto the elements of the application program and the associated capability list are erased. Accordingly, removing an application program can be simply effected by deleting the application program elements and the capabilities list, it is not required to modify any authorization registries in association with resources.

The above examples are schematically illustrated by arrow 851 shown in FIG. 8, illustrating the transfer of data and commands to the card device.

A further example is illustrated in view of arrow 852, illustrating a case where a number of capabilities lists in association with an application program or a group of application programs are transmitted to the card device 801. For example, if a large number of a resources is available on the card device 801, owned by various entities such as an operator of the card device 801, a user of the card device 801 and the like, a first capabilities list associated with the application program covers a first number of resources, such as a resource is owned by a first entity, e.g. the operator of the card device 801. Furthermore, a second capabilities list is transferred in association with the application program to the card device 801, covering resources owned by a second entity, such as a user of the card device 801. Again, if a corresponding application program needs to be removed from the card device 801 it is sufficient to simply remove all capabilities list associated with the application program, it is not required to modify access registries in association with individual resources.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A card device for communication with an electronic device, comprising:
a memory for storing a capabilities list associated with an application program, said capabilities list including information regarding access to one or more resources for use by said application program, and for storing said application program and a security manager; and
a processing unit for executing said application program and said security manager, said security manager for selectively granting access to said one or more resources for use by said application program based at least in part on said capabilities list.

2. The card device of claim 1 wherein said one or more resources comprise at least one of data and functions.

3. The card device of claim 1 wherein said one or more resources comprise one or more resources external to said card device.

4. The card device of claim 3, further comprising at least one of:
terminal side resources; and
channels of a communications network.

5. The card device of claim 1 wherein said one or more resources comprise one or more resources owned by at least one of said application program and another entity.

6. The card device of claim 5 wherein said other entity comprise at least one of:
an operating system of said card device; and
another application program.

7. The card device of claim 1 wherein said capabilities list comprises information regarding at least one of:
access rights; and
information required for access to a resource.

8. The card device of claim 1 wherein said memory stores a first capabilities list and a second capabilities list, said first capabilities list comprising a handle to link to said second capabilities list.

9. The card device of claim 8 wherein said second capabilities list is associated with one or more of other application programs.

10. The card device of claim 1 wherein said application program is for requesting access to a resource.

11. The card device of claim 1 wherein
said application program is for transmitting a resource access request to a security manager; and
said security manager is for transmitting a verify request to a verification program to examine said capabilities list to determine whether said application program is authorized to access said resource, and for performing or denying said requested action based at least in part on said examination.

12. The card device of claim 11 wherein said security manager comprises an application program interface (API).

13. The card device of claim 11 wherein said security manager is for obtaining information regarding said requesting application program through one of inquiring at a context originating the resource access request and a parameter provided with said resource access request.

14. The card device of claim 1, further comprising input/output means for receiving said capabilities list from at least one of a provider of said application program and an owner of said one or more resources.

15. The card device of claim 1 wherein said capabilities list and said application program constitute a load package received by said card device.

16. The card device of claim 1 wherein said device is configured to modify said capabilities list based at least in part on a subsequently received capabilities update list associated with said application program.

17. The card device of claim 1 wherein said device is configured to delete said capabilities list or link and access rights upon receiving an instruction to delete said application program from the outside.

18. The card device of claim 1 wherein
said capabilities list is encrypted; and
said processor is configured to decrypt said capabilities list.

19. The card device of claim 1 wherein
said capabilities list is cryptographically signed by at least one of a provider of said application program and an owner of said one or more resources; and
said processor is configured to cryptographically authenticate said capabilities list.

20. The card device of claim 19 wherein said processor is further configured to cryptographically authenticate said capabilities list when said capabilities list is stored on said device.

21. The card device of claim 19 wherein said processor is further configured to cryptographically authenticate said capabilities list when said capabilities list is accessed, said capabilities list being successfully authenticated if a first fingerprint computed over said capabilities list upon storing capabilities list matches a second fingerprint computed over said capabilities list in response to a run-time request to use said capabilities list.

22. The card device of claim 1 wherein said application program comprises a plurality of modules.

23. The card device of claim 1 wherein said application program comprises a Java application program or a Java Card™ applet.

24. The card device of claim 1 wherein said capabilities list is embodied in a tag-length-value (TLV) structure.

25. A method for controlling a card device, the card device for communication with an electronic device, the method comprising:
storing an application program on said card device;
storing a capabilities list associated with said application program on said card device, said capabilities list comprising information regarding access to one or more resources for use by said application program; and
executing said application program and a security manager, said security manager for selectively granting access to said one or more resources for use by said application program based at least in part on said capabilities list.

26. The method of claim 25 wherein said one or more resources comprise at least one of data and functions.

27. The method of claim 25 wherein said one or more resources comprise one or more resources external to said card device.

28. The method of claim 27 wherein said card device further comprises at least one of:
terminal side resources; and
channels of a communications network.

29. The method of claim 25 wherein said one or more resources comprise one or more resources owned by at least one of said application program and another entity.

30. The method of claim 29 wherein said other entity comprises at least one of:
an operating system of said card device; and
another application program.

31. The method of claim 25 wherein said capabilities list comprises information regarding at least one of:
access rights; and
information required for access to a resource.

32. The method of claim 25 wherein said information included in said memory stores a first capabilities list and a second capabilities list, said first capabilities list comprising a handle to link to said second capabilities list.

33. The card device of claim 32 wherein said second capabilities list is associated with one or more of other application programs.

34. The method of claim 25 wherein said executing further comprises said application program requesting access to a resource.

35. The method of claim 25 wherein said executing further comprises:
said application program transmitting a resource access request to said security manager; and
said security manager transmitting a verify request to a verification program to examine said capabilities list to determine whether said application program is authorized to access said resource, and performing or denying the requested action based at least in part on said examination.

36. The method of claim 35 wherein said security manager comprises an application program interface (API).

37. The method of claim 35 wherein said security manager obtains information regarding said requesting application program through and least one of inquiring at a context originating said resource access request, and a parameter provided with said resource access request.

38. The method of claim 25, further comprising receiving said capabilities list from at least one of a provider of said application program and an owner of said one or more resources.

39. The method of claim 25 wherein said capabilities list and said application program are comprised in a load package received by said card device.

40. The method of claim 25, further comprising modifying said capabilities list based at least in part on a subsequently received capabilities update list associated with said application program.

41. The method of claim 25, further comprising deleting said capabilities list or link and access rights upon receiving an instruction to delete said application program from the outside.

42. The method of claim 25 wherein
said capabilities list is encrypted; and
said method further comprises decrypting said capabilities list.

43. The method of claim 25 wherein
said capabilities list is cryptographically signed by at least one of a provider of said application program and an owner of said one or more resources; and
said method further comprises cryptographically authenticating said capabilities list.

44. The method of claim 25, further comprising cryptographically authenticating said capabilities list when said capabilities list is stored on said device.

45. The method of claim 25, further comprising cryptographically authenticating said capabilities list when said capabilities list is accessed, said capabilities list being successfully authenticated if a first fingerprint computed over said capabilities list upon storing capabilities list matches a second fingerprint computed over said capabilities list in response to a run-time request to use said capabilities list.

46. The method of claim 25 wherein said application program comprises a plurality of modules

47. The method of claim 25 wherein said application program comprises a Java application program or a Java Card™ applet.

48. The method of claim 25 wherein said capabilities list is embodied in a tag-length-value (TLV) structure.

49. A program storage device readable by a machine, embodying a program of instructions executable by the machine to perform a method for controlling a card device, the card device for communication with an electronic device, the method comprising:
storing an application program on said card device;
storing a capabilities list associated with said application program on said card device, said capabilities list comprising information regarding access to one or more resources for use by said application program; and
executing said application program and a security manager, said security manager for selectively granting access to said one or more resources for use by said application program based at least in part on said capabilities list.

50. The program storage device of claim 49 wherein said one or more resources comprise at least one of data and functions.

51. The program storage device of claim 49 wherein said one or more resources comprise one or more resources external to said card device.

52. The program storage device of claim 51 wherein said card device further comprises at least one of:
terminal side resources; and
channels of a communications network.

53. The program storage device of claim 49 wherein said one or more resources comprise one or more resources owned by at least one of said application program and another entity.

54. The program storage device of claim 53 wherein said other entity comprises at least one of:
an operating system of said card device; and
another application program.

55. The program storage device of claim 49 wherein said capabilities list comprises information regarding at least one of:
access rights; and
information required for access to a resource.

56. The program storage device of claim 49 wherein said information included in said memory stores a first capabilities list and a second capabilities list, said first capabilities list comprising a handle to link to said second capabilities list.

57. The program storage device of claim 56 wherein said second capabilities list is associated with one or more of other application programs.

58. The program storage device of claim 49 wherein said executing further comprises said application program requesting access to a resource; and

59. The program storage device of claim 49 wherein said executing further comprises:
said application program transmitting a resource access request to said security manager; and
said security manager transmitting a verify request to a verification program to examine said capabilities list to determine whether said application program is authorized to access said resource, and performing or denying the requested action based at least in part on said examination.

60. The program storage device of claim 59 wherein said security manager comprises an application program interface (API).

61. The program storage device of claim 59 wherein said security manager obtains information regarding said requesting application program through and least one of inquiring at a context originating said resource access request, and a parameter provided with said resource access request.

62. The program storage device of claim 49, said method further comprising receiving said capabilities list from at least one of a provider of said application program and an owner of said one or more resources.

63. The program storage device of claim 49 wherein said capabilities list and said application program are comprised in a load package received by said card device.

64. The program storage device of claim 49, said method further comprising modifying said capabilities list based at least in part on a subsequently received capabilities update list associated with said application program.

65. The program storage device of claim 49, said method further comprising deleting said capabilities list or link and access rights upon receiving an instruction to delete said application program from the outside.

66. The program storage device of claim 49 wherein
said capabilities list is encrypted; and
said method further comprises decrypting said capabilities list.

67. The program storage device of claim 49 wherein
said capabilities list is cryptographically signed by at least one of a provider of said application program and an owner of said one or more resources; and
said method further comprises cryptographically authenticating said capabilities list.

68. The program storage device of claim 67, said method further comprising cryptographically authenticating said capabilities list when said capabilities list is stored on said device.

69. The program storage device of claim 67, said method further comprising cryptographically authenticating said capabilities list when said capabilities list is accessed, said capabilities list being successfully authenticated if a first fingerprint computed over said capabilities list upon storing capabilities list matches a second fingerprint computed over said capabilities list in response to a run-time request to use said capabilities list.

70. The program storage device of claim 49 wherein said application program comprises a plurality of modules.

71. The program storage device of claim 49 wherein said application program comprises a Java application program or a Java Card™ applet.

72. The program storage device of claim 49 wherein said capabilities list is embodied in a tag-length-value (TLV) structure.

73. An apparatus for controlling a card device, the card device for communication with an electronic device, the apparatus comprising:
means for storing an application program on said card device;
means for storing a capabilities list associated with said application program on said card device, said capabilities list comprising information regarding access to one or more resources for use by said application program; and
means for executing said application program and a security manager, said security manager for selectively granting access to said one or more resources for use by said application program based at least in part on said capabilities list.

74. The apparatus of claim 73 wherein said one or more resources comprise at least one of data and functions.

75. The apparatus of claim 73 wherein said one or more resources comprise one or more resources external to said card device.

76. The apparatus of claim 75 wherein said card device further comprises at least one of:
terminal side resources; and
channels of a communications network.

77. The apparatus of claim 73 wherein said one or more resources comprise one or more resources owned by at least one of said application program and another entity.

78. The apparatus of claim 77 wherein said other entity comprises at least one of:
an operating system of said card device; and
another application program.

79. The apparatus of claim 73 wherein said capabilities list comprises information regarding at least one of:
access rights; and
information required for access to a resource.

80. The apparatus of claim 73 wherein said information included in said memory stores a first capabilities list and a second capabilities list, said first capabilities list comprising a handle to link to said second capabilities list.

81. The card device of claim 80 wherein said second capabilities list is associated with one or more of other application programs.

82. The apparatus of claim 73 wherein said means for executing further comprises said means for requesting access to a resource.

83. The apparatus of claim 73 wherein said means for executing further comprises:
said application program transmitting a resource access request to said security manager; and
said security manager transmitting a verify request to a verification program to examine said capabilities list to determine whether said application program is authorized to access said resource, and performing or denying the requested action based at least in part on said examination.

84. The apparatus of claim 73 wherein said security manager comprises an application program interface (API).

85. The apparatus of claim 73 wherein said security manager obtains information regarding said requesting application program through at least one of inquiring at a context originating said resource access request, and a parameter provided with said resource access request.

86. The apparatus of claim 73, further comprising means for receiving said capabilities list from at least one of a provider of said application program and an owner of said one or more resources.

87. The apparatus of claim 73 wherein said capabilities list and said application program are comprised by in a load package received by said card device.

88. The apparatus of claim 73, further comprising means for modifying said capabilities list based at least in part on a subsequently received capabilities update list associated with said application program.

89. The apparatus of claim 73, further comprising means for deleting said capabilities list or link and access rights upon receiving an instruction to delete said application program from the outside.

90. The apparatus of claim 73 wherein
said capabilities list is encrypted; and
said method further comprises decrypting said capabilities list.

91. The apparatus of claim 73 wherein
said capabilities list is cryptographically signed by at least one of a provider of said application program and an owner of said one or more resources; and
said method further comprises cryptographically authenticating said capabilities list.

92. The apparatus of claim 91, further comprising means for cryptographically authenticating said capabilities list when said capabilities list is stored on said device.

93. The apparatus of claim 91, further comprising means for cryptographically authenticating said capabilities list when said capabilities list is accessed, said capabilities list being successfully authenticated if a first fingerprint computed over said capabilities list upon storing capabilities list matches a second fingerprint computed over said capabilities list in response to a run-time request to use said capabilities list.

94. The apparatus of claim 73 wherein said application program comprises a plurality of modules

95. The apparatus of claim 73 wherein said application program comprises a Java application program or a Java Card™ applet.

96. The apparatus of claim 73 wherein said capabilities list is embodied in a tag-length-value (TLV) structure.

97. A memory for storing data for access by an application program being executed on a data processing system, comprising:
a data structure stored in said memory, said data structure including information used by said application program to determine at run-time information regarding access to one or more resources for use by said application program.

98. The memory of claim 97 wherein said memory is for storing said application program and said data structure.

99. The memory of claim 98 wherein said application program and said data structure are contiguous in said memory.

100. The memory of claim 98 wherein said data structure is stored within said application program in said memory.
